(19) United States
(12) Patent Application Publication
(10) Pub. No.: US 2010/0113096 A1
(43) Pub. Date: May 6, 2010

(54) AERIAL SYSTEM, IN PARTICULAR MOBILE COMMUNICATION AERIAL SYSTEM, AND ASSOCIATED TRANSMISSION AND CONTROL DEVICE

(76) Inventors: Alexander SEEOR, Kolbermoor (DE); Markus MOHR, Rosenheim (DE); Roland GABRIEL, Griesstatt (DE)

Correspondence Address: NIXON & VANDERHYE, PC, 901 NORTH GLEBE ROAD, 11TH FLOOR, ARLINGTON, VA, 22203, US

(21) Appl. No.: 12/609,994

(22) Filed: Oct. 30, 2009

Related U.S. Application Data
(60) Provisional application No. 61/110,136, filed on Oct. 31, 2008.

(30) Foreign Application Priority Data
Oct. 30, 2008 (DE) 102008053851.5

(51) Int. Cl. H04M 1/00

(52) U.S. Cl. 455/562.1

(57) ABSTRACT

An aerial transmission control device has a converter circuit. The converter circuit has at least one connection on the base station side, and at least one connection on the aerial side. The converter circuit is constructed so that when a load is connected, a power drawing which can be ascertained via the connection on the aerial side is measured in the converter, and so that at at least one connection on the base station side, the measured power drawing is fed in in the form of a protocol signal.

The invention relates to an aerial system, in particular a mobile communication aerial system, and an associated transmission and control device according to the pre-characterising clause of claim 1.

Mobile communication aerials can radiate and/or receive in one or more frequency bands, for example in a 900 MHz band, an 1800 MHz band, a 1900 MHz band, or for example in a UMTS band, thus for example in a range from about 1920 MHz to 2170 MHz. In principle there are no restrictions to other frequency ranges.

Proven mobile communication aerials work with radiators or radiator devices which, for example, can transmit and/or receive in two polarisations which are perpendicular to each other. In this respect, X polarisation is also often mentioned, since the two polarisation planes are in principle aligned at a +45° angle and a −45° angle respectively to the horizontal plane or vertical plane. Irrespective of this, the main radiation direction of mobile communication aerials is often set at a radiation angle which differs from a horizontal alignment, and which preferably can be changed by remote control. This involves remotely controllable electronic down-tilt angle adjustment, and an associated adjustment device, often also called an RET unit for short.

Such a controller is to be taken as known, for example, from EP 1 356 539 B1, and such a method of operating such an RET unit from, for example, EP 1 455 413 B1.

Irrespective of the construction of the aerial systems in the region of a base station, it is necessary that the corresponding aerial systems should be synchronised with each other.

According to most mobile communication standards, the synchronisation of the base station is also ensured via a network and switching system, called “NSS” for short, and also known as the backbone network.

Satellite signals are not required here, since the subscribers are synchronised in the appropriate connection channel. The basic properties of such a mobile communication system are reproduced in, for example, P. Jung: Analyse and Entwurf digitaler Mobilfunksysteme Verlag Teubner, Stuttgart, 1997, pp. 231-240.

Against this background, the mobile communication network is constantly expanded and/or modernised by providing new mobile communication systems, if appropriate at the same location, in particular at the same mast. In conventional mobile communication systems, on the aerial side, electronic components (for example low-noise reception amplifiers) are often provided, for example in the form of current-alarmed devices (also sometimes called “CWA devices” for short in the following, the abbreviation “CWA” standing for “current window alarm”). Newer aerial systems are also equipped, for example, with so-called AISG device functions (where AISG stands for “antenna interface standards group”). Aerial systems are also equipped, for example, with 3GPP device functions, which allow communication not via the AISG protocol, but via the 3GPP protocol (where “3GPP” stands for “3rd generation partnership project”).

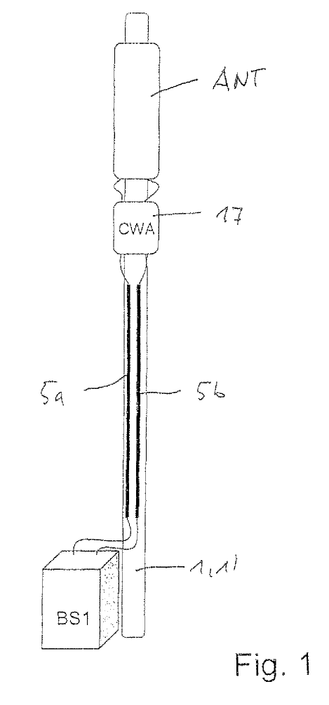

In the following, reference is made to FIG. 1, in which a conventional aerial system is shown as an example, it being possible to mount the associated aerial device at a mounting location 1, for example in the form of a mast 1′ (or on a housing or building, etc.). This aerial system includes, for example, the suitable radiator described above, for example an X-polarised radiator, to transmit and/or receive in two polarisations.

The conventional base station which is shown in FIG. 1, and which for example is to be modernised, in addition to the aerial device ANT, includes, for example, active aerial components such as low-noise reception amplifiers (TMA), which cannot be controlled via a protocol. Such devices work, for example, on the basis of “current alarming”, i.e. include CWA logic and/or CWA devices, which draw different currents depending on fault changes and/or status changes. On this basis, status and fault states of the components can be controlled and/or monitored. For this purpose, for example, a conventional base station BS1, indicated in FIG. 1, is equipped with CWA logic and/or CWA control devices. For example, an aerial-side CWA device unit 17, which is connected upstream from the associated aerial device ANT, is connected via two HF/DC connecting lines 5a and 5b to the base station BS1, so that via the HF/DC connecting lines 5a and 5b, the radiators belonging to the aerial device ANT can be controlled correspondingly to operate the aerial system.

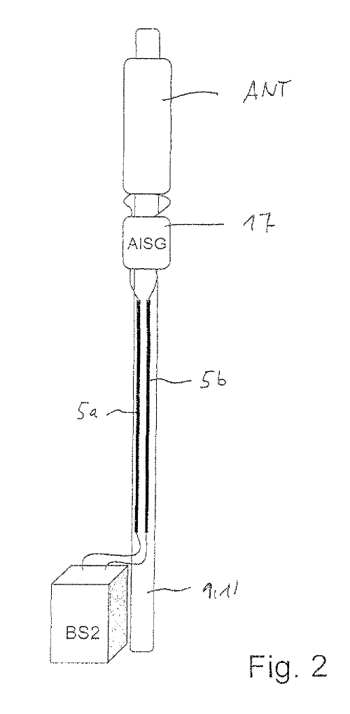

On the basis of FIG. 2, it is now shown that, for example, the old base station BS1 shown in FIG. 1 is to be replaced by a new, more modern base station BS2. For example, according to FIG. 2 the new base station is to be equipped with the AISG (antenna interface standards group) functions, which thus control communication with the aerial device and the associated aerial components, for example in the form of low-noise aerial amplifiers, on the basis of the AISG protocol. This therefore makes it necessary that the CWA devices and components 17 which are provided on the aerial side and indicated in FIG. 1 (i.e. the so-called current-alarmed devices) must also be replaced, to control these devices on the basis of the AISG protocol.

Differing from the example reproduced in FIG. 2, renewal of a conventional base station BS1 by replacing it with a new base station BS2, which is equipped not with the above-mentioned AISG device functions but with 3GPP device functions, which allow communication via the 3GPP protocol, would also come into consideration. In this case, therefore, the CWA components shown in FIG. 1 would also have to be replaced with aerial components 17 which can be controlled on the basis of the 3GPP protocol. Other protocols are in principle possible and conceivable, and the corresponding devices must then be matched to these protocols.

As part of modernisation, for example, a so-called RET unit, i.e. a so-called remotely controllable electronic down-tilt device, can be retrofitted on the aerial device shown in FIG. 2. With this, the lowering angle of the radiator provided in the aerial device can for example be set differently. These RET units too are mobile communication components 17 which are provided on the aerial side, and for example can be provided in addition to TMA amplifiers (i.e. so-called low-noise tower mounted amplifiers).

The object of this invention is to create a possibility for modernising a conventional aerial system, in particular a mobile communication aerial system, which has advantages compared with the modernisation concepts which have been carried out until now.

According to the invention, the object is achieved with reference to a transmission and control device corresponding to the features given in claim 1, and with reference to an aerial system, in particular a mobile communication aerial system, corresponding to the features given in claim 10. Advantageous versions of the invention are given in the subclaims.

In the known solutions according to the prior art until now, it was necessary, in modernising a conventional mobile communication system, which for example worked with current-alarmed ALD devices, when replacing the old base station and installing a newer, more modern base station, also to replace the current-alarmed ALD devices with corresponding aerial-side protocol-controlled devices, for example devices which work and/or can be controlled using an AISG protocol or 3GPP protocol. in contrast, within the invention it is now possible to leave the CWA-based device components which are provided on the aerial side, i.e. not to replace them, but merely to modernise the base station, a converter circuit according to the invention being connected upstream from the aerial device, before or after the transmission path of the feeders, so as to provide in this way the corresponding simulation and provision of the required direct voltage to control the CWA components.

The converter circuit according to the invention can be constructed so that it is suitable as a complementary solution for specified manufacturer-specific base stations, and designed for a quite specific transmission protocol, for example an AISG protocol, or a 3GPP protocol, etc. By contrast, however, it is also possible to provide and use a converter circuit according to the invention, which scans its connections on the base station side, i.e. those connections to which the HF feeders coming from the base station are also connected (one HF feeder for polarisation being provided in each case). Through this scanning process, it is possible to determine in the converter circuit whether the relevant connected or renewed base station transmits control data, for example, on the basis of an AISG protocol, a 3GPP protocol or another suitable protocol. Then, in accordance with the scan result, it is possible to set up a connection in the relevant converter circuit according to the invention in such a way that the ALD devices which are connected on the aerial side (and which therefore, as current-alarmed devices, draw different currents depending on fault changes and/or status changes) are controlled correspondingly, and/or their faults or status changes are transmitted to the base station, or the corresponding information can be made available on enquiry or polling, for example by the base station.

In this case, the necessary direct voltage for the CWA devices provided on the aerial side can also be made available at the appropriate level via the new base station.

Thus with the above-mentioned converter circuit according to the invention, corresponding provision of direct voltage for the CWA devices, precisely at the order of magnitude which was required until now for the CWA devices, is also possible.

The explained converter circuit can thus use the energy of the base station, but only within the limits which are also allowed for standardised AISG-3GPP components. The currents—measured in the converter—of the CWA device connected upstream are used only to detect operational and/or fault states, and are not mapped onto the current consumption of the converter side on the base station side. If the current level which the base station provides is insufficient, preferably the required direct current is made available via a separate interface of the converter circuit.

In a preferred embodiment of the invention, a further separate interface, which can be used either to control the converter itself, and/or to control the aerial arrangement which can be reached via it, and/or to provide direct current for active aerial components (including CWA devices), is provided on the relevant converter circuit.

This mentioned additional interface on the converter circuit can also be omitted in the case of sufficient total direct current power at the base station.

Further advantages, details and features of the invention result from the attached embodiments on the basis of drawings. In detail:

FIG. 1: shows an example of a conventional aerial system according to the prior art, with a base station;

FIG. 2: shows an example of modernisation of a conventional aerial system, a current-alarmed base station and current-alarmed aerial components and devices being replaced by a base station which conforms to protocol, using appropriately protocol-controlled aerial components;

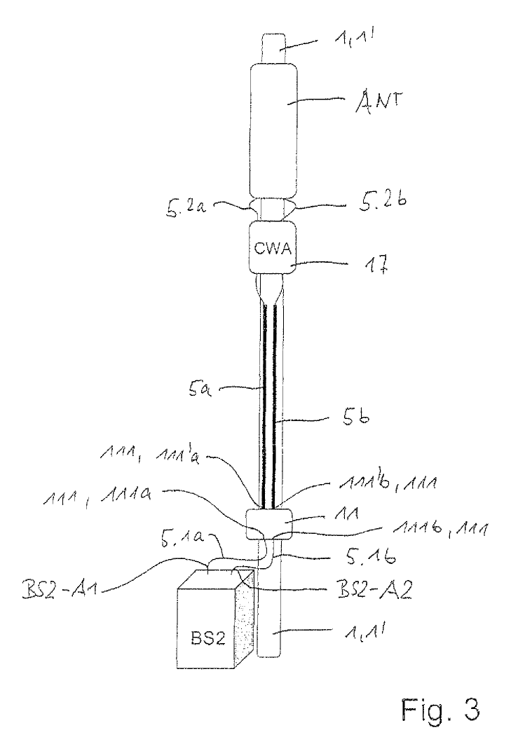

FIG. 3: shows an example of a renewed aerial system according to the invention, in which, starting from the known aerial arrangement according to the prior art and FIG. 1, the base station was renewed and a converter device according to the invention was additionally installed;

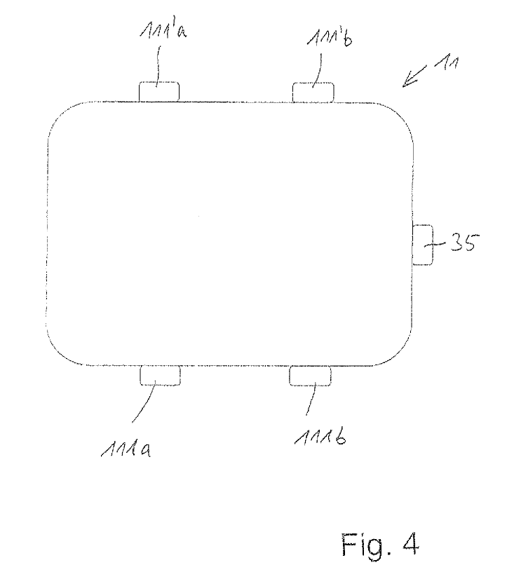

FIG. 4: is a schematic representation of the converter according to the invention, with its connections including an additional connection; and

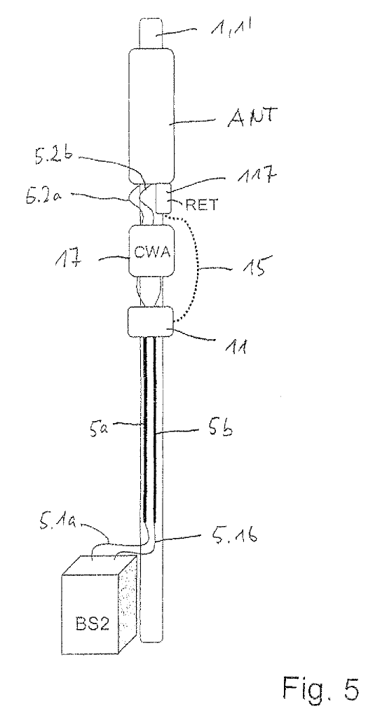

FIG 5: is a view similar to FIG. 3, in which the converter device is not provided near the base station, but near the aerial, at the other end of the HF feed link.

Below, reference is made to FIG. 3.

FIG. 3 shows a first embodiment according to the invention, in which starting from a conventional mobile communication system according to FIG. 1 a conventional base station BS1 has been replaced by a newer base station BS2.

Thus the aerial system according to FIG. 3 further includes an aerial device ANT, of which FIG. 3 essentially shows only the radome, below which the usually multiple radiator devices, which for example radiate in one, two or more frequency bands, are provided. Preferably, the transmission and/or reception operation takes place in two mutually perpendicular polarisation planes. In this respect, reference is made to known solutions.

On a mast 1′, in principle only two feed lines 5a and 5b are available.

The aerial system ANT is also controlled and/or operated on the aerial side via current-alarmed (CWA) ALD mobile communication components 17, which are connected to the associated aerial ANT via two HF connecting lines 5.2a and 5.2b.

In this embodiment too, for one polarisation the output BS2-A1 is connected via a base-station-side connecting line 5.1a to a first input 111a of a converter 11, and the aerial-side connection 111′a of the converter 11 is connected via the HF feed line 5a to one input of the aerial-side current-alarmed ALD mobile communication component 17.

For the second polarisation, a further base-side connecting line 5.1b is connected to a second input 111b of the converter 11, the aerial-side second connection 111′b of the converter being connected via the second HF feed line 5b (with reference to the second polarisation) to the aerial-side second input of the current-alarmed ALD mobile communication component 17.

The drawing does not show that via the two shown HF feed links 5a, 5b from the base station BS2 to the aerial device ANT, not only the HF signals, but also the associated direct current supply for current alarming take place.

For operation, it is now provided that the converter device 11 measures the power consumption or current drawing at its aerial-side interfaces, and depending on these measured values, communicates the fault and/or operational state of the aerial-side CWA mobile communication component to the base station, preferably via an AISG/3GPP protocol, and/or makes this information available for interrogation by the base station. The information signal which is transmitted by the converter 11 to the base station BS2 can be, for example, an HDLC signal, i.e. a so-called “High-Level Data Link Control” signal.

By contrast, a corresponding information signal can also take place immediately on the basis of an AISG protocol, a 3GPP protocol or similar, i.e. in general on the basis of such a protocol which is used on the side of the associated base station BS2. On the base station side, the converter device 11 preferably behaves like a standardised AISG or 3GPP mobile communication component. In general, therefore, a conversion is carried out in the converter, preferably into a protocol which for data and information exchange to the base station BS2 can be alternately transmitted to the converter, received and correspondingly analysed and converted.

The above-mentioned information signal (for example HDLC) or a corresponding AISG or 3GPP protocol signal may relate to the measured current or a failure state, for example with reference to a low-noise reception amplifier, or with reference to two low-noise reception amplifiers TMA which are provided in one housing and are as provided for the aerial device ANT.

The converter circuit 11 controls and/or handles the required modulation, demodulation, power transformation and regulation of the current consumption.

Depending on the construction of the converter circuit, it is also possible to ensure that the corresponding power supply is separated from the current and power supply for the base station. In other words, the power supply for the converter unit (and the ALD devices) can be provided separately externally to the base station.

If a corresponding aerial system is to be put into operation, the following starting scenario is possible:
1. The direct current and pilot bypasses on the converter unit 11 are open.
2. The base station makes available a required proportion of the power supply (which may be provided by an external power supply) for the aerial-side components, and feeds this power, for example at 12 V DC, into the HF feed line.
3. The base station transmits the pilot signal to one of the base station connections, BS2-A1 or BS2-A2.
4. The converter 11 interrogates its aerial-side connections and interfaces for whether current-alarmed ALD components 17 are connected (for example whether or not a direct current short circuit is present).
5. To supply the connected current-alarmed ALD components 17 with appropriate power (direct current), the converter 11 will activate the required power, depending on the ALD state, and make it available. This power can be made available by the base station, either completely or partly.
6. The converter continuously measures the power supply of a connected ALD component 17, and thus determines fault and/or operational states of the ALD component, and makes these available to the base station, for example on the basis of the AISG protocol or similar.
7. The base station at least partly merges a corresponding direct current via one of the two feed lines 5a and/or 5b, and feeds this to the converter 11 (also to supply current to it), which then either makes the required direct current available via an unchanged direct voltage or, for example, converts it by means of a switched-mode power supply into the required direct voltage, so that a corresponding direct current can then be fed to the mobile communication component 17 for current supply.

If it does not correspond to the relevant direct current power for the connected ALT devices, then the DC power which the base station BS2 makes available is transformed (for example by means of a switched-mode power supply) into a suitable DC voltage (for example 12 V) and fed into the appropriate feeder cable 5a or 5b to supply the installed ALD devices and/or components 17.

An additional or total required DC power drawing of the ALD devices and components and of the converter 11 can be made available to the system as required via a further interface 35 in addition to the for example four shown connections 111 on the relevant converter, on which subject reference is made below to FIG. 4.

FIG. 3 shows schematically the converter circuit according to the invention, with two connections via which a connection is made via the two lines 5.1a and 5.1b to the new base station BS2, and via which the HF signals are therefore fed. On the aerial side, two connections, via which, in the embodiment according to FIG. 3, the two HF feed lines 5a and 5b lead from the converter circuit 11 to the CWA devices and/or CWA components 17, are also provided.

FIG. 4 further shows the mentioned additional interface 35, which for example is provided as an additional interface, and for example can function as an AISG or 3GPP interface or connection point, also in order to provide as required, via this additional interface, a direct current voltage supply for aerial-side ALD devices and components 17, and/or to make configuration of the converter possible.

The mentioned additional interface 35 can thus be used for an additional or total required DC power drawing of all ALD devices and components and for operation and/or configuration of the converter circuit.

The converter connections facing the aerial side are de-energised and high-resistance at first. The converter connections facing the base station are also high-resistance at first. A corresponding DC voltage (for example that of the base station) is present at these.

The converter checks each of its aerial-side outputs for any connected DC loads (for example double low-noise reception amplifiers DTMA, provided bias tee circuits SST or, for example, existing RET circuits for remotely controllable setting of the down-tilt angle), and regularly (the time interval preferably being configurable) measures their current drawing. The DC voltage which is present on an HF feed line (feeder) is only switched through to the ANT converter output(s) which is/are also connected to a DC load. All converter outputs are short-circuit-resistant.

A configuration setting which is given by the system can be preset via further converter interfaces. The power which is drawn on the base station side is always used to supply the connected loads and the converter circuit.

The converter 11 also monitors its base-station-side connections 111a, 111b for any protocol signals (for example AISG, 3GPP or other protocols which are different from these) which are present. This monitoring can take place statically or by multiplexing.

From the explained construction, it is clear that the above-mentioned additional converter interface 35 can also be omitted, in the case of a sufficient total direct current power at the connections on the base station side. Similarly, via the optional additional interface 35 on the converter, communication can take place with the ALD devices and components 17 which can be reached via it, for example for setting and monitoring the ALD communication independently of the base stations, for example in the case of a system installation, if the base station is not yet installed.

The converter can be configured both via its HF connections (for example via the connections 111a, 111b on the base station side) and via the additional interface 35.

FIG. 5 only schematically shows that the converter 11 according to the invention can be arranged not near the base station (for example at the bottom end of the mast 1′), but in the top end region of the mast 1′, near the aerial ANT, for example directly before a CWA device unit or component 17. This would not actually lead to any changes in the functionality. This converter too would be constructed and operated as described above.

The embodiments have been explained for converters which are provided in effect as separate devices or components in the region of the base station before the HF transmission link, or near the associated aerial device at the other end of the HF link which usually runs above the mast or a building.

However, the explained converter 11 can, for example, also be integrated, with its corresponding functions, into an aerial device ANT, a CWA device or a CWA component 17, or the associated base station BS1 to BS2.

In FIG. 5, a so-called RET unit, i.e. a remotely controllable electronic down-tilt device 117, which for example can communicate with the converter 11 via a separate data line 15 or be controlled via it, is also drawn in. This data line 15 can also be used to supply direct current to the RET unit 117. This data line 15 can, for example, be connected via the separate connection 35 (FIG. 4) and control the RET unit 117 via it. The corresponding data of the RET unit can also be transmitted via the data line 15 in the reverse direction, to the converter and then, via the feed lines or at least via one of the two feed lines 5a, 5b, to the base station. If required, the RET unit can be supplied with a direct voltage which differs from the direct voltage of the mobile communication component 17, if appropriate again using a switched-mode power supply, which can be provided in the converter 11.

From the explained description, it can be seen that the converter supports and carries out the function of mapping different ALD devices into the base station. This means, therefore, that the communication interfaces of the individual ALD devices can migrate into the appropriate base station. This makes it possible particularly conveniently, to replace an older base station using current-alarmed CWA ALD devices or components with a newer base station (which, for example, works on the basis of a 3GPP protocol), without having to replace a corresponding current-alarmed ALD device. This possibility of replacement also applies to base stations of different manufacturers.

To summarise it can thus be established that the converter according to the invention is in the form of a “protocol converter”, which translates and converts a current-alarming changeover (CWA direct current consumption magnitudes) into an AISG or, for example, 3GPP protocol.

This combination of such a converter with, for example, a current-alarmed TMA (low-noise aerial amplifier), thus maps this onto an input amplifier which conforms to AISG or 3GPP.

As explained, the protocol recognition can take place statically or dynamically, at the converter connections on the base station side. However, since when an old base station is replaced and a new base station is installed, the protocol basis on which the control should and can take place is always defined, the above-mentioned permanent monitoring of the converter inputs on the base station side with regard to specified protocol signals being present can also be omitted.

1. Aerial transmission control device, comprising:
a converter circuit,
the converter circuit having at least one connection on the base station side, and at least one connection on the aerial side,
the converter circuit being constructed so that when a load is connected, a power drawing which can be ascertained via the connection on the aerial side measured in the converter, and
the converter circuit being constructed so that the information about the result of the power measurement at at least one connection on the aerial side is made available at a connection on the base station side.

2. Aerial transmission control device according to claim 1, wherein the converter circuit is constructed so that a current-alarmed state or fault signal which is present at the at least one connection on the aerial side is mapped onto the connection on the base station side, and conforms to protocol, being converted into a signal which conforms to AISG or 3GPP.

3. Aerial transmission control device according to claim 1, wherein the converter circuit is constructed so that a direct current signal which is fed into the converter circuit at the connection on the base station side is fed into the at least one connection on the aerial side.

4. Aerial transmission control device according to claim 1, wherein the converter circuit is constructed so that it has an additional connection, a direct voltage which can be fed into the additional connection being fed into the connection on the aerial side.

5. Aerial transmission control device according to claim 3, wherein direct voltage(s) which is/are fed into the converter circuit at its connection on the base station side and/or at its additional connection can be converted into a direct voltage of different magnitude, which is fed into the at least one connection on the aerial side.

6. Aerial transmission control device according to claim 1, wherein the connections on the converter circuit which are provided on the aerial side are de-energised and high-resistance before operation begins.

7. Aerial transmission control device according to claim 1, wherein the connections of the converter circuit on the base station side are high-resistance before operation begins, even if direct voltages are present.

8. Aerial transmission control device according to claim 1, wherein the converter circuit on the aerial side is constructed so that the connections which are provided on the aerial side are tested at a preferably configurable time interval for connected direct current consumption, with regard to their current drawing.

9. Aerial transmission control device according to claim 1, wherein all connections of the converter circuit on the aerial side are short-circuit-resistant.

10. A mobile communication aerial system, comprising:
at least one base station,
at least one aerial device,
at least one HF feed line, via which the transmission and/or reception signals are transmitted between the base station and the associated aerial device, the aerial device being able to receive and/or transmit in at least one polarisation plane,
at least one aerial component, which is switched between the at least one HF feed line and radiators in the at least one associated aerial device (ANT),
the aerial device or at least one aerial component which is connected upstream from the aerial device is controlled and monitored on the basis of current alarming,
the base station being constructed in such a way that it can transmit and receive protocol-controlled signals and analyse them accordingly in order to operate the aerial device, and
a converter circuit according to claim 1 provided between the base station and the at least one current-alarmed aerial component.

11. Aerial system according to claim 10, wherein from the base station side, aerial control and/or control of mobile communication components takes place on the basis of a protocol, in particular an AISG or 3GPP protocol or a different transmission protocol from them.

12. Aerial system according to claim 10, wherein the direct voltage which is present at the converter circuit via the at least one feed line can be switched through unchanged or adjusted only at that connection of the converter circuit on the aerial side to which an aerial component which consumes direct current is connected.

13. Aerial system according to claim 10, wherein at least two HF feed lines are provided, and the converter circuit is connected in their link.

14. Aerial system according to claim 10, wherein the converter circuit is connected near the base station.

15. Aerial system according to claim 10, wherein the converter circuit is provided near the aerial.
